(19) United States
(12) Patent Application Publication
(10) Pub. No.: US 2023/0376863 A1
(43) Pub. Date: Nov. 23, 2023

(54) ROUTE PLANNING METHOD AND DEVICE, EQUIPMENT AND STORAGE MEDIUM

(71) Applicant: LINGDONG TECHNOLOGY (BEIJING) CO.LTD, Beijing (CN)

(72) Inventor: Junlong LV, Beijing (CN)

(21) Appl. No.: 18/028,203

(22) PCT Filed: Jul. 30, 2021
(86) PCT No.: PCT/CN2021/109689

§ 371 Date: Mar. 23, 2023

(30) Foreign Application Priority Data
Sep. 25, 2020 (CN) 202011026082.9
Sep. 25, 2020 (WO) PCT/CN2021/109689

(51) Int. Cl. G06Q 10/047; G01C 21/20; G06Q 10/087; G05D 1/02

(52) U.S. Cl. CPC G06Q 10/047; G01C 21/206; G06Q 10/087; G05D 1/0287; G05D 2201/0216

(57) ABSTRACT

Disclosed are a route planning method and device, equipment and a storage medium. The method comprises: selecting at least two mobile devices from a plurality of mobile devices; determining routes of the at least two mobile devices and a plurality of stopping positions on the routes to stop; and cross-allocating the plurality of stopping positions to the at least two mobile devices according to a passing sequence of the plurality of stopping positions on the routes. By adopting this method, when any one of the at least two mobile devices moves to its own stopping position to wait, other mobile devices can move to their own stopping positions in advance to wait. In this way, the time consumed for each mobile device to move to the corresponding stopping position can be reduced.

### CROSS REFERENCE TO RELATED APPLICATIONS

This application refers to Chinese Patent Application No. 2020110260829 filed on Sep. 25, 2020, entitled “Route Planning Method and Device, Equipment and Storage Medium”, the entire contents of which are hereby incorporated by reference.

### TECHNICAL FIELD

The invention relates to the technical field of logistics, in particular to a route planning method and device, equipment and a storage medium.

### BACKGROUND

In the related art, a mobile device is provided for each order picker, which may be a cargo vehicle. The mobile device obtains a picking route and stopping positions on the route in advance, and can stop at each stopping position according to the route. Every time the mobile device stops, the goods that the order picker needs to pick can be found on a shelf next to the stopping position of the mobile device.

Generally, the walking speed of the order picker is faster than the traveling speed of the mobile device, so the order picker has to wait for the mobile device after walking to the stopping position, and only after the mobile device arrives can picking operation be performed. After picking operation at one stopping position, both the order picker and the mobile device need to move to the next stopping position.

Because of the low moving speed of the mobile device, the picking speed is limited. The long time consumed for the mobile device to arrive at each stopping position reduces the picking efficiency.

### SUMMARY

The invention provides a route planning method and device, equipment and a storage medium, which are used for improving the picking efficiency.

In a first aspect, the invention provides a route planning method, which comprises:

selecting at least two mobile devices from a plurality of mobile devices;

determining routes of the at least two mobile devices and a plurality of stopping positions on the routes to stop; and

cross-allocating the plurality of stopping positions to the at least two mobile devices according to a passing sequence of the plurality of stopping positions on the routes.

Optionally, cross-allocating the plurality of stopping positions to the at least two mobile devices according to a passing sequence of the plurality of stopping positions on the routes comprises:

acquiring stopping positions one-by-one from the plurality of stopping positions according to the passing sequence on the routes;

acquiring the mobile devices one-by-one from the at least two mobile devices if a current device is not a last mobile device among the at least two mobile devices, and acquiring the mobile devices one-by-one from a first mobile device among the at least two mobile devices if the current device is the last mobile device among the at least two mobile devices; and

allocating the currently acquired stopping position to the currently acquired mobile device every time a stopping position and a mobile device are acquired.

Optionally, selecting at least two mobile devices from a plurality of mobile devices comprises:

acquiring order information corresponding to the plurality of mobile devices respectively; and

determining the route and stopping positions corresponding to each mobile device based on an order information corresponding to the each mobile device, and determining at least two mobile devices with routes and stopping positions meeting preset conditions among the plurality of mobile devices.

Optionally, determining at least two mobile devices with routes and stopping positions meeting preset conditions among the plurality of mobile devices comprises:

determining at least two mobile devices with a same route and stopping positions being staggered on the route among the plurality of mobile devices.

Optionally, determining a plurality of stopping positions on the route to stop comprises:

acquiring order information of an order;

acquiring a plurality of stopping positions to stop on the route from the order information when the order information comprises the plurality of stopping positions to stop on the route; or

determining a plurality of stopping positions corresponding to identifiers of items to be picked up based on a pre-established correspondence between item identifiers and stopping positions when the order information comprises the identifiers of the items to be picked up.

Optionally, the method further comprises:

acquiring order information of an order, and sending the order information to the at least two mobile devices, so that the at least two mobile devices determine the respective routes and the respective stopping positions to stop on the routes based on the order information; or

sending the route of each mobile device and the stopping positions allocated to each mobile device to the at least two mobile devices.

In a second aspect, the invention provides a route planning device, comprising:

a selection module for selecting at least two mobile devices from a plurality of mobile devices;

a determination module for determining routes of the at least two mobile devices and a plurality of stopping positions on the routes to stop; and

an allocation module for cross-allocating the plurality of stopping positions to the at least two mobile devices according to a passing sequence of the plurality of stopping positions on the routes.

Optionally, the allocation module is used for:

acquiring stopping positions one-by-one from the plurality of stopping positions according to the passing sequence on the routes;

acquiring the mobile devices one-by-one from the at least two mobile devices if a current device is not a last mobile device among the at least two mobile devices, and acquiring the mobile devices one-by-one from a first mobile device among the at least two mobile devices if the current device is the last mobile device among the at least two mobile devices; and

allocating the currently acquired stopping position to the currently acquired mobile device every time a stopping position and a mobile device are acquired.

Optionally, the selection module is used for:

acquiring order information corresponding to the plurality of mobile devices respectively; and determining the route and stopping positions corresponding to each mobile device based on an order information corresponding to the each mobile device, and determining at least two mobile devices with routes and stopping positions meeting preset conditions among the plurality of mobile devices.

Optionally, the selection module is used for:

determining at least two mobile devices with a same route and stopping positions being staggered on the route among the plurality of mobile devices.

Optionally, the determination module is used for:

acquiring order information of an order;

acquiring a plurality of stopping positions to stop on the route from the order information when the order information comprises the plurality of stopping positions to stop on the route; or

determining a plurality of stopping positions corresponding to identifiers of items to be picked up based on a pre-established correspondence between item identifiers and stopping positions when the order information comprises the identifiers of the items to be picked up.

Optionally, the device further comprises:

a sending module for acquiring order information of an order, and sending the order information to the at least two mobile devices, so that the at least two mobile devices determine the respective routes and the respective stopping positions to stop on the routes based on the order information; or

the sending module is used for sending the route of each mobile device and the stopping positions allocated to each mobile device to the at least two mobile devices.

In a third aspect, the invention provides an electronic equipment, which comprises a processor and a memory, wherein an executable code is stored on the memory, and when executed by the processor, the executable code causes the processor to at least implement the route planning method in the first aspect.

In a fourth aspect, the invention provides a non-transitory machine-readable storage medium having an executable code stored thereon, which, when executed by a processor of an electronic equipment, causes the processor to at least implement the route planning method in the first aspect.

By adopting the method provided by the invention, when any one of the at least two mobile devices moves to its own stopping position to wait, other mobile devices can move to their own stopping positions in advance to wait. In this way, the time consumed for each mobile device to move to the corresponding stopping position can be reduced.

### BRIEF DESCRIPTION OF THE DRAWINGS

In order to explain the technical scheme of the invention more clearly, the drawings needed in the description of the invention will be briefly introduced below. Obviously, the drawings in the following description are some embodiments of the invention. For those of ordinary skill in the art, other drawings can be obtained according to these drawings without creative work.

FIG. 1 is a flowchart of a route planning method provided by the invention;

FIG. 2 is a diagram of routes and stopping positions provided by the invention;

FIG. 3 is a diagram of routes and stopping positions provided by the invention;

FIG. 4 is a diagram of a stopping position allocation result provided by the invention;

FIG. 5 is a structural diagram of a route planning device provided by the invention; and

FIG. 6 is a structural diagram of an electronic equipment provided by the invention.

### DETAILED DESCRIPTION OF EMBODIMENTS

In order to make the purpose, technical solution and advantages of the embodiments of the invention clearer, the technical solution in the embodiments of the invention will be described clearly and completely below with reference to the drawings in the embodiments of the invention. Obviously, the described embodiments are only part of the embodiments of the invention, not all of the embodiments. Based on the embodiments of the invention, all other embodiments obtained by those of ordinary skill in the art without creative labor are within the scope of the invention.

Terms used in the embodiments of the invention are for the purpose of describing specific embodiments only, and are not intended to limit the invention. As used in the embodiments of the invention and the appended Claims, the singular forms “a”, “said” and “the” are also intended to include the plural forms, and unless the context clearly indicates other meanings, “plural” generally means at least two kinds.

Depending on the context, the word “if” as used herein can be interpreted as “when” or “in response to determination” or “in response to detection”. Similarly, depending on the context, the phrase “if determined” or “if detected (stated condition or event)” can be interpreted as “when determined” or “in response to determination” or “when detected (stated condition or event)” or “in response to detection (stated condition or event)”.

In addition, the sequence of steps in each of the following method embodiments is only an example, and is not intended to be limiting.

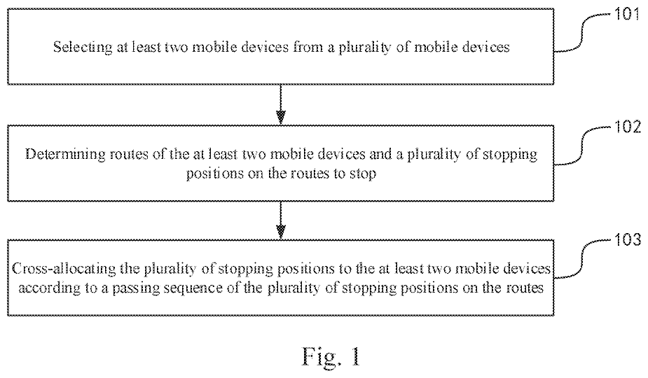

FIG. 1 is a flowchart of a route planning method provided by an embodiment of the invention. As shown in FIG. 1, the method comprises the following steps:

101, selecting at least two mobile devices from a plurality of mobile devices;

102, determining routes of the at least two mobile devices and a plurality of stopping positions on the routes to stop; and

103, cross-allocating the plurality of stopping positions to the at least two mobile devices according to a passing sequence of the plurality of stopping positions on the routes.

The mobile device may be a cargo vehicle, a self-propelled robot, etc. The method provided by the embodiment of the invention can be realized by a control and scheduling system and can be realized through the cooperation of a plurality of mobile devices.

In practical application, the method provided by the embodiment of the invention can be applied to various scenes, such as a picking scene, a distribution scene and the like. The specific implementation of the embodiment of the invention will be introduced below by taking the picking scene as an example, and other scenes can be implemented with reference to the implementation of the picking scene, which will not be repeated here.

In the picking scene, at least two mobile devices can be provided for each order picker, so that before or during the loading of goods by the order picker on one of the mobile devices, other mobile devices can move to the stopping positions where picking is needed in advance to wait for the order picker. In this way, the time consumed for each mobile device to move to the corresponding stopping position can be reduced, so that the overall picking efficiency can be improved.

In practical application, assuming that there are a plurality of mobile devices, at least two mobile devices can be selected from the plurality of mobile devices as the mobile devices to complete the picking task. Specifically, order information carrying the picking task can be obtained, and at least two mobile devices can be obtained from the plurality of mobile devices based on the order information.

On this basis, optionally, the process of selecting at least two mobile devices from the plurality of mobile devices may comprise: acquiring order information corresponding to the plurality of mobile devices respectively; and based on an order information corresponding to the each mobile device, determining the route and stopping positions corresponding to each mobile device, and determining at least two mobile devices with routes and stopping positions meeting preset conditions among the plurality of mobile devices.

In practical application, each mobile device can be assigned an order first, then the corresponding route and stopping positions of each mobile device can be determined according to the order assigned to each mobile device, and finally the mobile devices with routes and stopping positions meeting preset conditions can be classified as one group, so that multiple device groups are obtained.

Optionally, the process of determining at least two mobile devices with routes and stopping positions meeting preset conditions among the plurality of mobile devices can be implemented as: determining at least two mobile devices with a same route and stopping positions being staggered on the route among the plurality of mobile devices.

In practical application, assuming that each mobile device has a corresponding route and stopping positions on the route, at least two mobile devices with the routes being the same and the stopping positions on the route being staggered can be determined from the plurality of mobile devices according to the route and stopping positions corresponding to each mobile device.

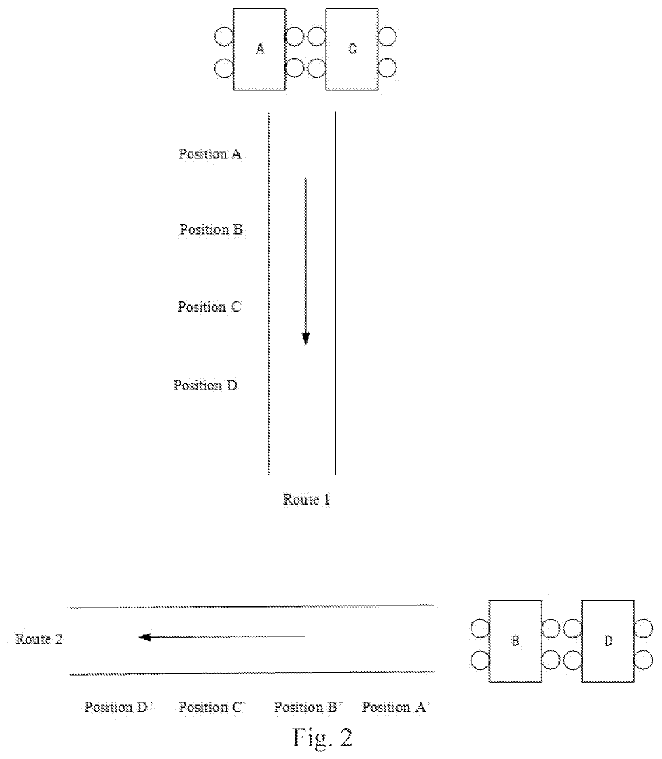

As shown in FIG. 2, for example, assuming that the route of the mobile device A is route 1, the route of the mobile device B is route 2, the route of the mobile device C is route 2, the route of the mobile device D is route 1, the mobile device A needs to stop at positions A and C on route 1, the mobile device D needs to stop at positions B and D on route 1, route 1 is a route in the north-south direction, the mobile devices need to go from north to south, and from north to south, there are position A, position B, position C and position D in turn, and then it can be seen that the routes taken by the mobile device A and the mobile device D are the same, and the stopping positions are staggered on the route according to the passing sequence, so the routes and stopping positions of the mobile device A and the mobile device D meet the preset conditions, and the mobile device A and the mobile device D can be classified as one group.

Further, the mobile device B needs to stop at positions A′ and C′ on route 2, the mobile device C needs to stop at positions B′ and D′ on route 2, route 2 is a route in the east-west direction, the mobile devices need to go from east to west, and from east to west, there are position A′, position B′, position C′ and position D′ in turn, and then it can be seen that the routes taken by the mobile device B and the mobile device C are the same, and the stopping positions are staggered on the route according to the passing sequence, so the routes and stopping positions of the mobile device B and the mobile device C meet the preset conditions, and the mobile device B and the mobile device C can be classified as one group.

After selecting at least two mobile devices for completing the order, the routes of the at least two mobile devices and a plurality of stopping positions on the routes can be determined. In the embodiment of the invention, two ways of determining the routes and the stopping positions are provided.

Optionally, order information of an order can be obtained. When the order contains a plurality of stopping positions on the route, the plurality of stopping positions on the route are obtained from the order; or when the order contains identifiers of the items to be picked up, determining a plurality of stopping positions corresponding to the identifiers of the items to be picked up based on a pre-established correspondence between item identifiers and stopping positions.

In practical application, if the order only contains information such as the identifiers of the items to be picked up and the quantity required for each item, a plurality of stopping positions corresponding to the identifiers of the items to be picked up can be determined based on a pre-established correspondence between item identifiers and stopping positions.

For example, assuming that there is an item identifier and stopping position comparison table stored locally and the identifiers of the items to be picked up contained in the order comprise item A and item B, then storage locations of item A and item B can be found in the comparison table, and then the storage locations of item A and item B can be used as stopping positions.

Alternatively, if besides information such as the identifiers of the items to be picked up and the quantity required for each item, the order also contains a plurality of stopping positions on the route of the at least two mobile devices, then the plurality of stopping positions contained in the order can be directly used.

After determining the plurality of stopping positions, route planning can be performed according to the plurality of stopping positions. After determining the routes and the plurality of stopping positions of the at least two mobile devices, the plurality of stopping positions can be cross-allocated to the at least two mobile devices.

Optionally, the process of cross-allocating the plurality of stopping positions to the at least two mobile devices according to a passing sequence of the plurality of stopping positions on the routes can be implemented as: acquiring the stopping positions one-by-one from the plurality of stopping positions according to the passing sequence on the route; if a current device is not a last mobile device among the at least two mobile devices, acquiring the mobile devices one-by-one from the at least two mobile devices, and if the current device is the last mobile device among the at least two mobile devices, acquiring the mobile devices one-by-one from a first mobile device among the at least two mobile devices; and every time a stopping position and a mobile device are acquired, allocating the currently acquired stopping position to the currently acquired mobile device.

For example, assuming that there are two mobile devices, mobile device X and mobile device Y, and they need to stop at eight stopping positions in total. The diagram of these eight stopping positions can be seen in FIG. 3. The eight stopping positions include: 11, 21, 12, 22, 13, 23, 14 and 24. As can be seen from FIG. 3, the route of the two mobile devices is a zigzag route. The stopping positions 11, 21, 12, 22, 13, 23, 14 and 24 are located on the zigzag route in turn.

The stopping positions can be obtained one-by-one from the stopping positions 11, 21, 12, 22, 13, 23, 14, and 24, and the mobile devices can be obtained one-by-one from the mobile devices X and Y. Because the number of the stopping positions is greater than the number of the mobile devices, one mobile device needs to be allocated to multiple stopping positions, so the stopping positions can be allocated to the mobile devices repeatedly.

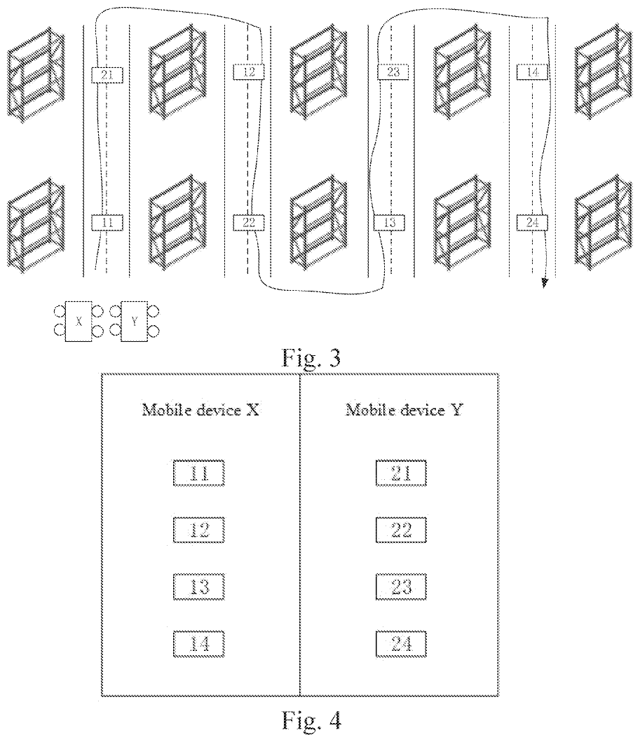

Assuming that the currently acquired stopping position is 11 and the currently acquired mobile device is mobile device X, then 11 can be allocated to the mobile device X. Then the stopping position 21 and the mobile device Y are acquired, and 21 is allocated to the mobile device Y. Since the allocation of both mobile devices have been finished, a new stopping position can be allocated to a first mobile device between the two mobile devices. Then the stopping position 12 can be acquired and the mobile device X is acquired, and 12 is allocated to the mobile device Y, and so on, until all the stopping positions are allocated to the mobile devices. The final allocation result is shown in FIG. 4.

It can be understood that after the control and scheduling system calculates the routes of the at least two mobile devices and the stopping positions allocated to the mobile devices respectively, the order information can optionally be sent to the at least two mobile devices, so that the at least two mobile devices can determine the routes of the mobile devices and the stopping positions on the routes based on the order information; or, the route of each mobile device and the stopping positions allocated to each mobile device are sent to the at least two mobile devices.

In practical application, in order to save the computing overhead of the mobile devices, the control and scheduling system can directly send the calculated routes of the at least two mobile devices and the stopping positions allocated to the mobile devices to the at least two mobile devices; or, the order information can be sent to the at least two mobile devices, so that the at least two mobile devices can calculate the routes of the at least two mobile devices and the stopping positions on the routes by using the same calculation mode as the control and scheduling system, and it is ensured that the routes calculated by the mobile devices are the same as those calculated by the control and scheduling system, and the stopping positions on the routes are also the same as those calculated by the control and scheduling system.

After knowing the routes and the stopping positions, the at least two mobile devices can automatically move to their respective first stopping positions, to wait for the order picker to pick the items. For any of the mobile devices, after finishing picking, the order picker can select an option for indicating picking completion through a human-computer interaction interface, so that the mobile device can receive a picking completion instruction, and based on the picking completion instruction, the mobile device can automatically move to its next stopping position to wait for the order picker.

By adopting the method provided by the embodiment of the invention, when any one of the at least two mobile devices moves to its own stopping position to wait, other mobile devices can move to their own stopping positions in advance to wait. In this way, the time consumed for each mobile device to move to the corresponding stopping position can be reduced.

In addition, because each mobile device has a fixed cargo weight, the overall cargo capacity of the mobile devices can be improved when a plurality of mobile devices are used for picking at the same time, and the problem that when one mobile device with limited cargo capacity is used for picking, the mobile device needs to move to an unloading place for unloading before picking is completed, and then return to the stopping position again can be avoided. Further, the time required for unloading the mobile devices is reduced, and the overall picking efficiency is further improved.

Route planning devices in one or more embodiments of the invention will be described in detail below. Those skilled in the art can understand that these route planning devices can be configured by the steps taught in this scheme using commercially available hardware components.

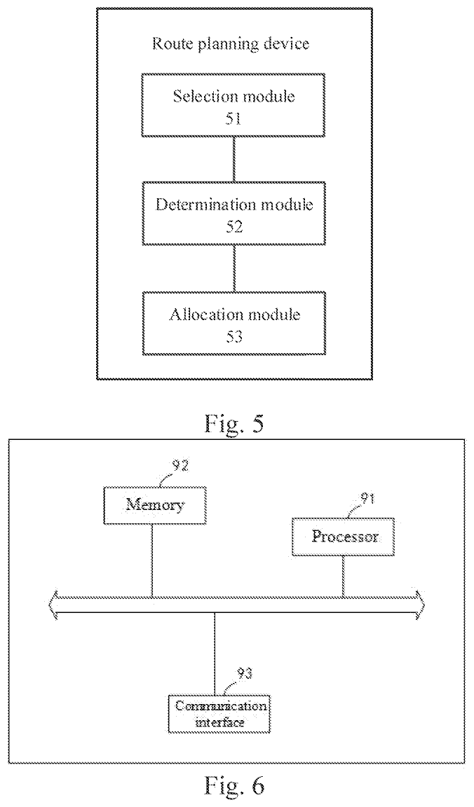

FIG. 5 is a structural diagram of a route planning device provided by an embodiment of the invention. As shown in FIG. 5, the device comprises.

a selection module 51 for selecting at least two mobile devices from a plurality of mobile devices;

a determination module 52 for determining routes of the at least two mobile devices and a plurality of stopping positions on the routes: and

an allocation module 53 for cross-allocating the plurality of stopping positions to the at least two mobile devices according to a passing sequence of the plurality of stopping positions on the routes.

Optionally, the allocation module 53 is used for:

acquiring stopping positions one-by-one from the plurality of stopping positions according to the passing sequence on the routes;

if a current device is not a last mobile device among the at least two mobile devices, acquiring the mobile devices one-by-one from the at least two mobile devices, and if the current device is the last mobile device among the at least two mobile devices, acquiring the mobile devices one-by-one from a first mobile device among the at least two mobile devices; and

every time a stopping position and a mobile device are acquired, allocating the currently acquired stopping position to the currently acquired mobile device.

Optionally, the selection module 51 is used for:

acquiring order information corresponding to the plurality of mobile devices respectively; and based on an order information corresponding to the each mobile device, determining the route and stopping positions corresponding to each mobile device, and determining at least two mobile devices with routes and stopping positions meeting preset conditions among the plurality of mobile devices.

Optionally, the selection module 51 is used for:

determining at least two mobile devices with a same route and stopping positions being staggered on the route among the plurality of mobile devices.

Optionally, the determination module 52 is used for:

acquiring order information of an order;

when the order information comprises a plurality of stopping positions on the route, acquiring the plurality of stopping positions on the route from the order information; or

when the order information comprises the identifiers of the items to be picked up, determining a plurality of stopping positions corresponding to the identifiers of the items to be picked up based on a pre-established correspondence between item identifiers and stopping positions.

Optionally, the device further comprises:

a sending module for acquiring order information of an order, and sending the order information to the at least two mobile devices, so that the at least two mobile devices determine the respective routes and the respective stopping positions to stop on the routes based on the order information; or

the sending module is used for sending the route of each mobile device and the stopping positions allocated to each mobile device to the at least two mobile devices.

The device shown in FIG. 5 can execute the route planning method as provided in the embodiments shown in FIGS. 1-4, and the detailed execution process and technical effects are described in the previous embodiments, which will not be repeated here.

In a possible design, the route planning device shown in FIG. 5 can be realized as an electronic equipment, as shown in FIG. 6, which may comprise a processor 91 and a memory 92, wherein an executable code is stored on the memory 92, and when executed by the processor 91, the executable code causes the processor 91 to at least realize the route planning method as provided in the embodiments shown in FIGS. 1-4.

Optionally, the electronic equipment may further comprise a communication interface 93 for communicating with other equipment.

In addition, an embodiment of the invention provides a non-transitory machine-readable storage medium having an executable code stored thereon, which, when executed by a processor of an electronic equipment, causes the processor to at least realize the route planning method as provided in the embodiments shown in FIGS. 1-4.

The device embodiments described above are only for illustration. The units described as separate components may or may not be physically separated. Some or all of the modules may be selected according to actual needs to achieve the purpose of the embodiment. One of ordinary skill in the art can understand and implement it without creative labor.

From the description of the above embodiments, those skilled in the art may clearly understand that each embodiment may be realized by means of necessary general hardware platforms, and of course, the embodiments may also be realized by combining hardware and software. Based on this understanding, the essence of the above technical scheme or the part that contributes to the prior art can be embodied in the form of computer products. The invention may take the form of a computer program product implemented on one or more computer usable storage media (including but not limited to magnetic disk memory, CD-ROM, optical memory, etc.) having computer usable program codes embodied therein.

The route planning method provided by the embodiment of the invention can be executed by a certain program/software, which can be provided by a network side. The electronic equipment mentioned in the aforementioned embodiment can download the program/software to a local nonvolatile storage medium, and when the aforementioned route planning method needs to be executed, the program/software can be read into a memory by a CPU, and then the program/software can be executed by the CPU to realize the route planning method provided in the aforementioned embodiment. The execution process can be seen in FIGS. 1-4.

Finally, it should be noted that the above embodiments are only used to illustrate the technical solutions of the invention, but not to limit the invention. Although the invention has been described in detail with reference to the foregoing embodiments, those of ordinary skill in the art should understand that the technical solutions described in the foregoing embodiments can still be modified, or some of the technical features can be equivalently replaced, and these modifications or substitutions do not make the essence of the corresponding technical solutions deviate from the spirit and scope of the technical solutions of the embodiments of the invention.

1. A route planning method, comprising:
selecting at least two mobile devices from a plurality of mobile devices;
determining routes of the at least two mobile devices and a plurality of stopping positions on the routes to stop; and
cross-allocating the plurality of stopping positions to the at least two mobile devices according to a passing sequence of the plurality of stopping positions on the routes.

2. The method according to claim 1, wherein cross-allocating the plurality of stopping positions to the at least two mobile devices according to a passing sequence of the plurality of stopping positions on the routes comprises:
acquiring stopping positions one-by-one from the plurality of stopping positions according to the passing sequence on the routes;
acquiring the mobile devices one-by-one from the at least two mobile devices if a current device is not a last mobile device among the at least two mobile devices, and acquiring the mobile devices one-by-one from a first mobile device among the at least two mobile devices if the current device is the last mobile device among the at least two mobile devices; and
allocating the currently acquired stopping position to the currently acquired mobile device every time a stopping position and a mobile device are acquired.

3. The method according to claim 1, wherein selecting at least two mobile devices from a plurality of mobile devices comprises:
acquiring order information corresponding to the plurality of mobile devices respectively; and
determining the route and stopping positions corresponding to each mobile device based on an order information corresponding to the each mobile device, and determining at least two mobile devices with routes and stopping positions meeting preset conditions among the plurality of mobile devices.

4. The method according to claim 3, wherein determining at least two mobile devices with routes and stopping positions meeting preset conditions among the plurality of mobile devices comprises:
determining at least two mobile devices with a same route and stopping positions being staggered on the route among the plurality of mobile devices.

5. The method according to claim 1, wherein determining a plurality of stopping positions on the route to stop comprises:
acquiring order information of an order;
acquiring a plurality of stopping positions to stop on the route from the order information when the order information comprises the plurality of stopping positions to stop on the route; or
determining a plurality of stopping positions corresponding to identifiers of items to be picked up based on a pre-established correspondence between item identifiers and stopping positions when the order information comprises the identifiers of the items to be picked up.

6. The method according to claim 1, further comprising:
acquiring order information of an order, and sending the order information to the at least two mobile devices, so that the at least two mobile devices determine the respective routes and the respective stopping positions to stop on the routes based on the order information; or
sending the route of each mobile device and the stopping positions allocated to each mobile device to the at least two mobile devices.

7. A route planning device, comprising:
a selection module for selecting at least two mobile devices from a plurality of mobile devices;
a determination module for determining routes of the at least two mobile devices and a plurality of stopping positions on the routes to stop; and
an allocation module for cross-allocating the plurality of stopping positions to the at least two mobile devices according to a passing sequence of the plurality of stopping positions on the routes.

8. The device according to claim 7, wherein the allocation module is used for:
acquiring stopping positions one-by-one from the plurality of stopping positions according to the passing sequence on the routes;
acquiring the mobile devices one-by-one from the at least two mobile devices if a current device is not a last mobile device among the at least two mobile devices, and acquiring the mobile devices one-by-one from a first mobile device among the at least two mobile devices if the current device is the last mobile device among the at least two mobile devices; and
allocating the currently acquired stopping position to the currently acquired mobile device every time a stopping position and a mobile device are acquired.

9. An electronic equipment, comprising a memory and a processor, wherein an executable code is stored on the memory, and when executed by the processor, the executable code causes the processor to implement the route planning method according to claim 1.

10. A non-transitory machine-readable storage medium having an executable code stored thereon, which, when executed by a processor of an electronic equipment, causes the processor to implement the route planning method according to claim 1.
